(19) United States
(12) Patent Application Publication
(10) Pub. No.: US 2003/0078001 A1
(43) Pub. Date: Apr. 24, 2003

(54) System and method for managing congestion in a satellite communications network

(76) Inventors: Steven Thompson, Germantown, MD (US); David Whitefield, Darnestown, MD (US); Arthur Kaupe, Chevy Chase, MD (US); Andrew Barnhart, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 09/974,934

(22) Filed: Oct. 11, 2001

(51) Int. Cl. H04B 7/185

(52) U.S. Cl. 455/12.1; 455/452; 455/453

(57) ABSTRACT

A system and method for controlling data congestion affecting user terminals in a communications network, such as satellite terminals in a satellite communications network. The system and method employs a congestion detector adapted to determine that data congestion exists in the network which interferes with an ability of at least one user terminal to communicate in the network, and a congestion controller, adapted to control downlinking of data from the network controller to at least one select group of the user terminals and uplinking of data from at least one select group of the user terminals to the network controller, in response to the data congestion. The congestion controller and control downlinking and uplinking of data to and from the select group or groups of terminals based on criteria such as user terminals which are all located within a single uplink cell or user terminals which are located within all uplink cells in said network.

### CROSS-REFERENCE TO RELATED APPLICATION

Related subject matter is disclosed in a copendinig U.S. Patent Application of Steven Thompson et al. entitled “A System and Method for Managing Interference Caused by Satellite Terminals in a Satellite Communications Network by Establishing and Using Virtual Cells which are Independent of the Cells Formed by the Spot Beams Generated by the Satellite”, Attorney Docket No. PD-200305, filed even date herewith, the entire contents of which is incorporated herein by reference.

### BACKGROUND OF THE INVENTION

1. Field of the Invention

The present invention relates to an improved system and method for managing congestion in a satellite communications network by establishing and using virtual cells which are independent of the cells formed by the spot beams generated by the satellite. More particularly, the present invention relates to a system and method that is capable of controlling downlinking and uplinking of data to and from satellite terminals in a satellite communications network based on desired parameters and independent of their presence in a particular spot beam or cell to reduce congestion in the network.

2. Description of the Related Art

Satellite communications networks exists which are capable of enabling transmission of various types of data, such as voice and mulitmedia data, to stationary and mobile user terminals. A satellite communications network includes one or more satellites, such as geosynchronous earth orbit (GEO) satellites, medium earth orbit (MEO) satellites, or low earth orbit (LEO) satellites which are controlled by one or more network operations control centers (NOCC). The satellites each project radio frequency communications signals in the form of spot beams onto the surface of the earth to provide the stationary or mobile user terminals access to the network.

That is, each spot beam irradiated by a satellite will cover a particular region of the earth's surface. Because GEO satellites orbit the earth at a speed substantially equal to that of the earth's rotation, spot beams generated by GEO satellite will each cover a designated area of the earth's surface. However, because MEO and LEO satellites orbit the earth at speeds which are typically much greater than the speed of rotation of the earth, the spot beams generated by these types of satellites will traverse the earth's surface.

A mobile user terminal is typically configured in the form of a hand-held unit, such as a mobile telephone having an antenna for transmitting and receiving signals, such as voice data signals, to and from the network. A stationary terminals, on the other hand, typically has a satellite dish which acts as the antenna for transmitting and receiving signals, such as voice, data or multimedia signals, to and from the network. These types of stationary terminals are typically referred to as satellite terminals or STs.

As can be appreciated by one skilled in the art, the STs within a region covered by a particular spot beam will transmit and receive data to and from the satellite communications network via the satellite in, for example, a time-division multiple access (TDMA) or code-division multiple access (CDMA) manner, over carrier waves having frequencies within the range of frequencies allocated to the spot beam. Each region is commonly referred to as a cell. Typically, networks of this type further divide their spot beams into smaller regions or cells by dividing the range of frequencies allocated to the spot beam into smaller ranges and allocating each of those smaller ranges to respective portions of the region covered by the spot beam. For example, a network may be configured so that each spot beam provides one uplink cell for receiving data from all of the STs in the cell, and a number of associated downlink cells, for example, seven downlink cells, with each downlink cell being used to transmit data from the network to a respective group of STs in a particular section of the spot beam.

The amount of bandwidth that the network can allocate to any particular ST within a cell is thus limited by the amount of bandwidth allocated to other STs within that cell. Typically, networks of this type are configured to allocate what is believed to be a sufficient amount of bandwidth to each uplink and downlink cell based on the number of STs that are believed to be in use in each cell. However, certain problems can arise if the resource use in a cell increases to a level that causes STs within the cell to be denied service.

For example, when a large number of STs are being activated at the same time in, for example, a “cold start-up case”, their initial requests for bandwidth and so on made to the system can cause heavy congestion in the data traffic of the system, and can also interfere with other STs already operating in the system. A similar situation can occur during a cold start-up of a NOCC during which the NOCC being activated attempts to downlink data to numerous STs at the same time. Some techniques exists which attempt to minimize such congestion by activating STs in a controlled manner, such as one by one or based on the cells in which they reside, or controlling the NOCC to provide downlink data to the STs in a similar manner. However, these techniques can be time consuming and can prove inadequate.

Accordingly, a need exists for an improved system and method for managing and minimizing such types of congestion.

### SUMMARY OF THE INVENTION

An object of the present invention is to provide a system and method for minimizing data congestion in a satellite communications network to control downlinking and uplinking of data to and from satellite terminals, especially during cold start-up instances.

Another object of the present invention is to provide a system and method that is capable of controlling downlinking and uplinking of data to and from satellite terminals in a satellite communications network based on desired parameters and independent of their presence in a particular spot beam or cell.

These and other objects are substantially achieved by providing a system and method for managing congestion in a communications network, such as a satellite communication network, which establishes communication cells at respective locations on the surface of the earth to enable communication between a plurality of user terminals, such as satellite terminals. The system and method employs a congestion detector adapted to detect data congestion in the network which interferes with an ability of at least one user terminal to communicate in the network, and a congestion controller, adapted to control downlinking of data from the network controller to at least one select group of the user terminals and uplinking of data from at least one select group of the user terminals to the network controller, based on criteria. On a cell by cell basis, the number of service requests into the NOCC are controlled by one broadcast message in each of the downlink cells instead of having to send a message to every terminal. Also, each NOCC service can be throttled independently.

### BRIEF DESCRIPTION OF THE DRAWINGS

These and other objects and advantages of the invention will become more apparent and more readily appreciated from the following detailed description of the presently preferred exemplary embodiments of the invention taken in conjunction with the accompanying drawings, of which:

FIG. 1 is a block diagram illustrating an example of a satellite communications network employing a system and method for controlling congestion according to an embodiment of the present invention; and

FIG. 2 is a detailed view of an arrangement of satellite terminals in cells formed by spotbeams projected by the satellite in the network shown in FIG. 1.

### DETAILED DESCRIPTION OF THE PREFERRED EMBODIMENTS

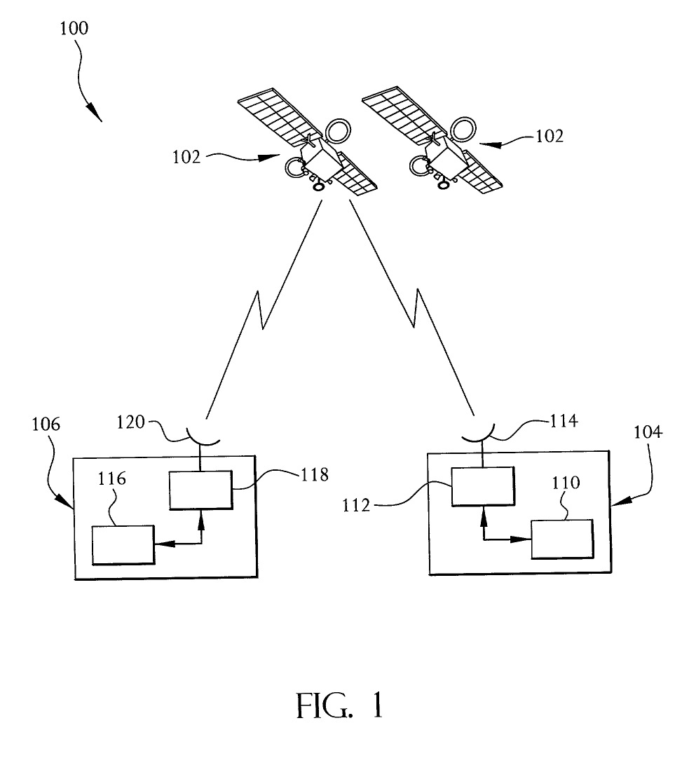

A satellite communications network 100 employing a system and method for congestion management according to an embodiment of the present invention is shown in FIG. 1. The network 100 includes one or more satellites 102, such as geosynchronous earth orbit (GEO) satellites, medium earth orbit (MEO) satellites, or low earth orbit (LEO) satellites which are controlled by one or more network operations control centers (NOCC) 104. In this example, the satellite 102 is a GEO satellite.

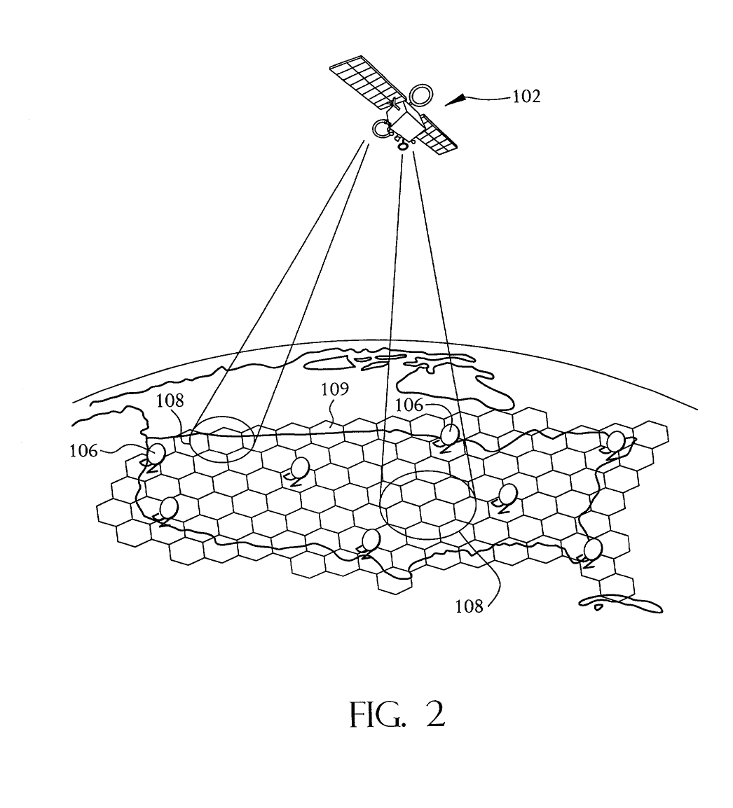

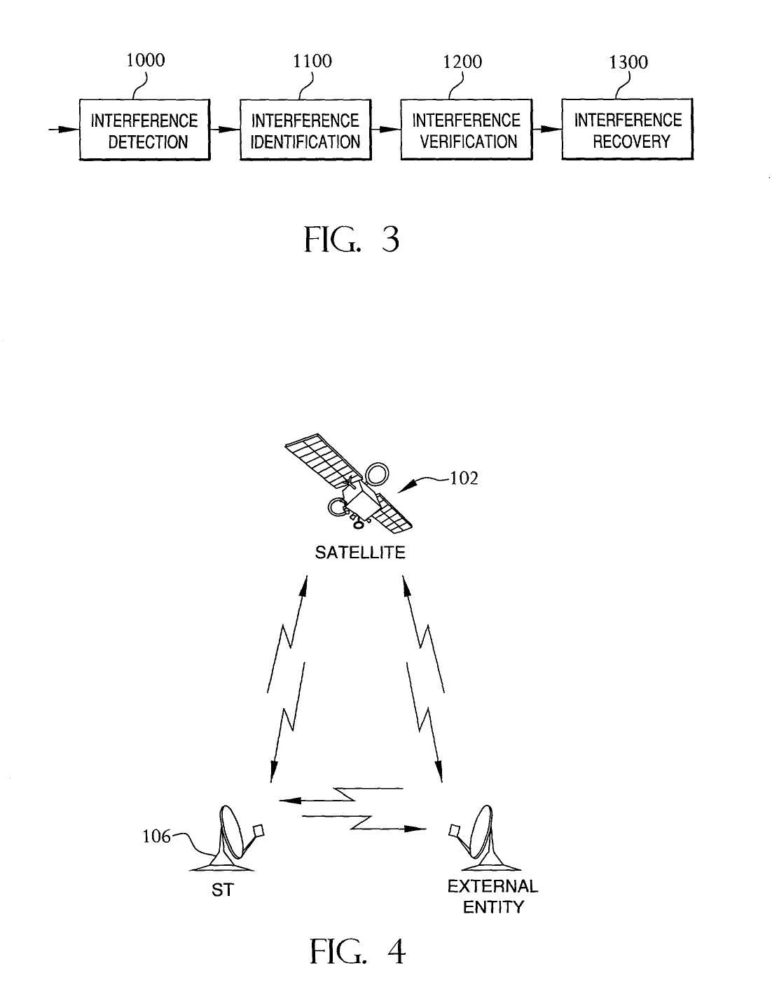

As discussed in the background section above, the satellite 102 projects radio frequency communications signals in the form of spot beams onto the surface of the earth to provide the stationary or mobile user terminals 106 access to the network. In this example, the user terminals 106 are stationary terminals or STs as described in the background section above. Because GEO satellites orbit the earth at a speed substantially equal to that of the earth's rotation, spot beams 108 generated by 104 satellite 102 will each cover a designated area of the earth's surface, as shown in FIG. 2. Each spot beam 108 includes one or more uplink and downlink cells 109 as can be appreciated by one skilled in the art. The satellite 102 is further capable of generating a CONUS beam which covers all of the regions covered by the individual spot beams 108.

As further shown in FIG. 1, the NOCC 104 includes a controller 110 for controlling operation of the satellite 102 and data communications to and from the STs 106 via the satellite 102 as discussed in more detail below. The NOCC 104 further includes a transceiver 112 coupled to an antenna 114, such as a satellite dish, for transmitting and receiving data signals, such as broadband, multimedia data signal, to and from the STs 106 via satellite 102. Each ST includes a controller 116 for controlling operation of the ST 106 and data communications to and from the NOCC 104 and other STs 106 via the satellite 102 as discussed in more detail below. The controller 116 includes a memory (not shown) for storing an identifier for the ST 106, such as a unique serial number, that is recognizable by the NOCC 104. Each ST 106 further includes a transceiver 118 coupled to an antenna 120, such as a satellite dish, for transmitting and receiving data signals, such as broadband, multimedia data signal, to and from the NOCC 104 and other STs 106 via satellite 102.

As shown in FIG. 2, a plurality of STs 106 can be present in each spot beam 108. As discussed in more detail below, the controller 110 of the NOCC 104 according to an embodiment of the present invention is capable of identifying and eliminating congestion in the network 100 that is caused by, for example, a rogue ST as discussed in the background section above. However, unlike the conventional networks, the controller 110 is capable of deactivating STs 106 independently of the spot beams 108, cells or regions of the earth in which they reside. The controller 110 is capable of deactivating groups of the STs 106 based on parameters such for an entire uplink cell in which the group of STs 106 reside, all STs 106 receiving a CONUS beam, or in any other suitable manner, as discussed in more detail below.

Examples of the operations performed by the NOCC 104 and other components of the network 100 will now be described in detail.

In the lifespan of a satellite communications network 100, congestion situations may arise where simply limiting traffic in certain downlink cells will not efficiently deal with the congestion and cannot be gracefully controlled. In this context, congestion means that the NOCC 104 is not able to process all of the service requests due to a lack of resources either at the NOCC 104 or on the satellite 102, but would be able to process some of the requests. This situation requires that the network 100 be able to limit NOCC service requests to the population of STs 106.

To address this situation, the NOCC 104 must be able to instruct the population of STs to either slow down the rate of requests for NOCC Services or stop requesting these services altogether. This feature will be utilized in at least two scenarios: NOCC 104 cold startup with a large population of STs 106 and slowing down or limiting access to NOCC service requests from STs during signaling congestion.

The NOCC 104 can configure ST congestion control parameters for each of the following NOCC service provided to the STs 106: security management, address resolution management, routing management, downlink power control, HVUL bandwidth management, reconciliation & downline load (DLL) management, alarms and events management, performance management, control, diagnostics accounting management, registration & authentication management, summary status, and capacity protection keys, to name a few. The NOCC 104 also provides the STs 106 in the management information packet a congestion level for each NOCC service. Each ST 106 inhibits its service requests to the NOCC 104 until it has received the current congestion status for each NOCC service. Also, each ST 106 recalculates its randomizing interval for each NOCC service based on the current congestion levels provided in the management information packet.

The NOCC 104 is capable of supporting at least eight different congestion levels for each service, and automatically adjusts the congestion levels for each service based on the resources available at the NOCC for processing the service requests. The network 100 shall update and transmit the MIP at least once every 30 seconds for at least the following information elements: NOCC Services, NOCC Routing, ST MGID IE, Security Keys IE, PCC Congestion IE. The starting time for the first Summary Status messages can be chosen randomly over the repeat time interval of the protocol.

For the NOCC 104 to control traffic in a startup situation, the NOCC 104 can inform the STs 106 that all NOCC services are congested for all STs. When the NOCC 104 is ready to start processing traffic, it will change the congestion levels of the NOCC Services parameters to unblock selected services. The NOCC 104 can continue to lower the congestion levels of NOCC services, as traffic allows, until all services are being provided with no congestion.

In order for the NOCC 104 to increase or decrease congestion levels for a given service, the NOCC 104 is able to determine when it is congested for any particular service. The criteria for a service being in a congested state may vary from service to service.

When the NOCC 104 determines that a service is congested, the NOCC 104 can increase the congestion level for that service and transmit this information to the STs 106. The NOCC 104 can continue to increase the congestion level for a service as long as it is determined to be congested, until the maximum level is reached.

When the NOCC 104 determines that a service is no longer congested, the NOCC 104 can decrease the congestion level for that service and transmit this information to the STs 106. The NOCC 104 can continue to decrease the congestion level for a service as long as it is determined not to be congested, until the minimum level is reached.

Upon startup, an ST 106 is not allowed to transmit a request for a NOCC service until receiving a NOCC Service Information Element. Therefore, the NOCC 104 can command the payload on the satellite 102 to transmit a MIP containing the NOCC Services Information Element at least, for example, every 30 seconds in order for the ST 106 to gain access to the services in a timely fashion. The NOCC 104 stores, as part of ST configuration data, a unique time period for each NOCC service that is congestion-controlled using a randomized back-off algorithm.

The NOCC 104 also associates a priority level for every ST 106 as a part of the ST's configuration data downloaded to the ST 106 during the commissioning process. This value shall be set to zero and is reserved for future expansion.

Listed below in Table 1 are examples of types of NOCC services that can be offered to the population of STs 106 within the network 100.

TABLE 1
Examples of Types of NOCC Services

| NOCC Service | Congestion Control | Algorithm Type | Valid Values |
|---|---|---|---|
| Security management | Auto | Randomized Back-off | Minimum |
| | | | through Maximum |
| Address Resolution | Auto | On/Off | Minimum |
| management | | | and Maximum |
| Routing management | Auto | Selective Blocking | Min - unrestricted |
| | | | 1-block route updates |
| | | | 2-block heartbeats |
| | | | Max - block everything |
| Point-to-point and | Auto | Connection | Minimum |
| Multicast Connection | | Management | through Maximum |
| management | | | |
| Downlink Power | Manual only | On/Off | Minimum |
| Control | | | and Maximum |
| Congestion | None | | |
| management (for future | | | |
| use) | | | |
| HVUL bandwidth | Auto | None - this value is | Minimum |
| management | | used to feed a separate | through Maximum |
| | | algorithm | |
| Reconciliation & | Auto | Randomized Back-off | Minimum |
| Downline Load (DLL) | | | through Maximum |
| management | | | |
| Alarms and Events | Manual only | Selective Blocking | Minimum |
| management | | | through maximum |
| | | | alarm severity plus 1 |
| Status (Health) | Auto | Randomized Back-off | Minimum |
| management | | | through Maximum |
| Performance | Auto | Randomized Back-off | Minimum |
| management | | | through Maximum |
| Control | None | | |
| Diagnostics | None | | |
| Accounting | Auto | Randomized Back-off | Minimum |
| management | | | through Maximum |
| Registration & | Auto | Randomized Back-off | Minimum |
| Authentication | | | through Maximum |
| management | | | |

Cold startup and congestion can be automatic and controlled by algorithms for each NOCC service. Any parameters used by the NOCC 104 for determining when a service is congested shall be configurable by a NOCC operator.

During normal operation and for each congestion-controlled NOCC service, the NOCC 104 can use the service requests and any internal metrics as continuous input an algorithm to determine the congestion level for the service. A NOCC operator can be able to manually set the congestion level for any NOCC Service and start transmitting this information over the network 100 for the purpose of altering the traffic over the network 100. In order for this manual feature to be used, the NOCC 104 should be able to disable the automatic control of setting congestion levels for NOCC services. If an operator wants to start transmitting custom congestion levels for NOCC services, the NOCC 104 should not automatically change the level until manual control is relinquished by the operator or a deadman timer.

In this example, there are four different algorithms an ST 106 can use in order to determine what NOCC services it can request and when it can request them. Not all NOCC services have congestion control and any level set for these services has no meaning and shall be ignored by the ST 106. For those NOCC services that are congestion controlled, each will use one of the algorithms described below.

Randomized Back-off: The ST 106 receives, as part of its configuration data from the NOCC 104, a time period for each NOCC service that uses a randomized back-off algorithm for congestion control. This time period is used with the congestion level to calculate a new time period in which the ST 106 can choose a random point within this time period to transmit the request for service. An algorithm can be defined where, for the minimum congestion level, the calculated time period is zero and a request can be sent immediately. When the maximum congestion level is used, the ST 106 cannot send a request at all and shall wait until the congestion level drops below the maximum before calculating a time period in which to transmit. The algorithm shall be exponential in nature.

On/Off: As expected, a simple on/off scheme where the minimum value represents an unrestricted service and the maximum value represents a fully blocked service. Any other value for this service shall be ignored and the service can be used in an unrestricted manner.

Selective Blocking: For services that use a selective blocking approach, pieces of the service are disabled as the congestion level rises instead of just shutting the service off or delaying a request. For Routing and Address Resolution, the services are disabled in the manner described in Table 2 below.

TABLE 2
Disabled Services for Routing and Address Resolution

| Congestion Level | Service to be Blocked |
|---|---|
| 0 | Unrestricted service |
| 1 | Block route updates |
| 2 | Block heartbeats |
| Maximum | Block everything |

For Alarm and Events, the congestion level corresponds to the severity of the Alarms or Events to be blocked shown by Table 3 below.

TABLE 3
Alarm and Events Blocked

| Congestion Level | Alarms and Events Blocked |
|---|---|
| 0 | Unrestricted service |
| 1 | Block severity level 0 |
| 2 | Block severity level 1 and below |
| 3 | Block severity level 2 and below |
| 4 | Block severity level 3 and below |
| 5 | Block severity level 4 and below |
| 6 | Block severity level 5 and below |

Before an ST 106 can request a service from the NOCC 104, it shall have already received a NOCC Services information element. This element contains all of the information an ST 106 needs to know about a service prior to requesting it, namely the IP address, SAP and congestion level. The starting time for the first routine heartbeat messages or foreground calibration messages shall be chosen randomly over the repeat time interval of the protocol. The priority level of the ST 106 is assigned at the time of commissioning and is part of the configuration data from the NOCC 104. The priority level shall be stored in non-volatile RAM.

Other operations and characteristics of the NOCC 104 will now be described.

The NOCC can associate a variable congestion level with every NOCC service, and can support a certain number (e.g., no more than 16) of different congestion levels for each NOCC service, with the highest congestion level representing a blocked service The NOCC 104 can include the congestion level for each service in the same message for informing the population of STs 106 about NOCC services. The NOCC can store, as a part of the ST configuration data, a separate time period for each type of NOCC service that uses a randomized back-off algorithm for congestion control. The NOCC 104 can also use separate algorithms for detecting and measuring congestion for each NOCC service that is automatically congestion controlled.

Upon NOCC cold start, all congestion levels can be set to the highest value for those NOCC services which are automatically congestion controlled. The NOCC can automatically decrease the individual congestion level for each congestion controlled NOCC service as traffic allows until all NOCC services are available. The NOCC can automatically increase the congestion level for a congestion controlled service as the resources for that service are allocated to the point of congestion, and can automatically decrease the congestion level for a congestion controlled service as the resources for that service are de-allocated to a point where the service is not congested at the current level.

A NOCC operator shall be able to override the automatic task of congestion levels for NOCC services. Reverting to automatic setting of congestion levels for NOCC services can be initiated by the NOCC operator or by a configurable deadman timer. Also, any parameters used by the NOCC 104 to determine the congestion level for a service can be configurable by the NOCC operator. The NOCC 104 can command the payload of the satellite 102 to transmit a MIP containing the NOCC Services Information Element at desired intervals, for example, at least every 30 seconds. The starting time for the first routine heartbeat messages or foreground calibration messages can be chosen randomly over the repeat time interval of the protocol.

Further characteristics and operations of the STs 106 will now be described.

The ST 106 can receive as part of its configuration data a separate time value from the NOCC 104 for each type of NOCC service that uses randomized back-off for congestion control. The ST 106 can use the congestion level of a NOCC service and the time value for the service in an algorithm for determining an interval in which to transmit a request for service for NOCC services that use a randomized back-off algorithm for congestion control. The ST 106 can select a random period within the time interval calculated in which to transmit its request for a NOCC service that use a randomized back-off algorithm for congestion control. Also, the ST 106 can use the most current congestion level received from the NOCC 104 as input to its algorithm for determining when to transmit a request for service. For example, a NOCC service with congestion level 0 (zero) shall represent an unrestricted service, while a NOCC service with the maximum value indicates that the ST shall not transmit a request for NOCC service at all. Furthermore, the ST 106 can implement a backoff timer between 0 and 5 minutes before sending a Capacity Key request if it holds 1 valid key.

In summary, the system and method according to the embodiments of the present invention described above is capable of controlling the NOCC 104, STs 106 and payload of the satellite 102 to manage congestion in the network 100 caused by, for example, cold start-up of the NOCC 104, the STs 106, or both. The system and method are further capable of controlling the manner in which the NOCC 104 dowlinks data to the STs 106, and the manner in which the STs 106 uplink data to the NOCC 104, based on any of the following: uplink cell by uplink cell, one uplink cell at a time, or all STs 106 receiving a CONUS beam. However, the system and method can further control the NOCC 104 and satellite 102 to downlink and uplink data to and from the STs 106 based on any desirable criteria independent or dependent on the uplink and downlink cells in which the STs 106 reside. Furthermore, the system and method need not be limited to a satellite communications network, but rather, can be employed in any other suitable network, such as a terrestrial-based network, and so on, having user terminals.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A system for managing data congestion in a communications network which establishes communication cells at respective locations on the surface of the earth to enable communication between a plurality of user terminals and at least one network controller, comprising:
a congestion determiner, adapted to determine that data congestion exists in said network which interferes with an ability of at least one user terminal to communicate in said network; and
a congestion controller, adapted to control at least one of downlinking of data from said network controller to at least one select group of said user terminals and uplinking of data from said at least one select group of said user terminals to said network controller, in response to said determined data congestion.

2. A system as claimed in claim 1, wherein:
said communications network includes a satellite communications network and said user terminals include satellite terminals; and
said congestion controller controls said at least one of said downlinking and uplinking of said data to and from at least one select group of said satellite terminals.

3. A system as claimed in claim 1, wherein:
said congestion controller controls said at least one of said downlinking and uplinking of said data to and from said at least one select group of user terminals which are all located within a single uplink cell.

4. A system as claimed in claim 1, wherein:
said congestion controller controls said at least one of said downlinking and uplinking of said data to and from said at least one select group of user terminals which are located within multiple cells .

5. A system as claimed in claim 1, wherein:
said congestion controller controls said at least one of said downlinking and uplinking of said data to and from said at least one select group of user terminals located within all uplink cells of said network.

6. A method for managing congestion in a communications network which establishes communication cells at respective locations on the surface of the earth to enable communication between a plurality of user terminals and at least one network controller, comprising:
determining the existence of data congestion in said network which interferes with an ability of at least one user terminal to communicate in said network; and
controlling at least one of downlinking of data from said network controller to at least one select group of said user terminals and uplinking of data from at least one select group of said user terminals to said network controller, in response to said data congestion.

7. A method as claimed in claim 6, wherein:
said communications network includes a satellite communications network and said user terminals include satellite terminals; and
said congestion controlling controls said at least one of said downlinking and uplinking of said data to and from at least one select group of said satellite terminals.

8. A method as claimed in claim 6, wherein:
said congestion controlling controls said at least one of said downlinking and uplinking of said data to and from said at least one select group of user terminals which are all located within a single cell.

9. A method as claimed in claim 6, wherein:
said congestion controlling controls said at least one of said downlinking and uplinking of said data to and from said at least one select group of user terminals which are located within multiple cells.

10. A method as claimed in claim 6, wherein:
said congestion controlling controls said at least one of said downlinking and uplinking of said data to and from said at least one select group of user terminals located within all uplink cells of said network.

11. A computer-readable medium of instructions, adapted to control a communications network to manage congestion in a communications network which establishes communication cells at respective locations on the surface of the earth to enable communication between a plurality of user terminals and at least one network controller, comprising:
a first set of instruction, adapted to control the communications network to determine that data congestion exists in said network which interferes with an ability of at least one user terminal to communicate in said network; and
a second set of instruction, adapted to control at least one of downlinking of data from said network controller to at least one select group of said user terminals and uplinking of data from at least one select group of said user terminals to said network controller, in response to said determined data congestion.

12. A computer-readable medium of instructions as claimed in claim 11, wherein:
said communications network includes a satellite communications network and said user terminals include satellite terminals; and
said second set of instructions controls said at least one of said downlinking and uplinking of said data to and from at least one select group of said satellite terminals.

13. A computer-readable medium of instructions as claimed in claim 11, wherein:
said second set of instructions controls said controls said at least one of said downlinking and uplinking of said data to and from said at least one select group of user terminals which are all located within a single cell.

14. A computer-readable medium of instructions as claimed in claim 11, wherein:
said second set of instructions controls said at least one of said downlinking and uplinking of said data to and from said at least one select group of user terminals which are located within multiple cells.

15. A computer-readable medium of instructions as claimed in claim 11, wherein:
said second set of instructions controls said at least one of said downlinking and uplinking of said data to and from said at least one select group of user terminals which are located in all uplinks cells of said network.
